(19) United States
(12) Patent Application Publication
(10) Pub. No.: US 2025/0008166 A1
(43) Pub. Date: Jan. 2, 2025

(54) OPTIMIZATION OF LIVE STREAM PRODUCTIONS

(71) Applicant: International Business Machines Corporation, Armonk, NY (US)

(72) Inventors: Gregory M. J. H. Tkaczyk, Mississauga (CA); Alexia Konstantinidi, London (GB); Andrew James Hudson, Caldicot (GB)

(73) Assignee: International Business Machines Corporation, Armonk, NY (US)

(21) Appl. No.: 18/215,640

(22) Filed: Jun. 28, 2023

(51) Int. Cl. H04N 21/2187; H04N 21/235; H04N 21/24; H04N 21/4788

(52) U.S. Cl. CPC H04N 21/2187; H04N 21/2353; H04N 21/2407; H04N 21/4788

(57) ABSTRACT

An embodiment optimizes a live stream event by annotating a script with markers for a live stream event. The embodiment defines an element within the live stream event. The embodiment defines a performance milestone within the element. The embodiment associates a first action with the performance milestone. The embodiment constructs a trigger within the script. The embodiment associates the trigger with a corresponding second action. The embodiment monitors the live stream event for the performance milestone and actuates the first action in response to the performance milestone. The embodiment monitors the live stream event for the trigger and actuates the second action in response to the trigger. The first and the second actions are real time changes to the live stream event.

### BACKGROUND

The present invention relates generally to video streaming through online networks. More particularly, the present invention relates to a method, system, and computer program for improving production of online video making through optimizing the management of local peripherals or stream enhancements during a live stream production.

Live streaming has exploded in popularity as a source of content generation for entertainment, education, and other information sharing or social purposes. Viewer habits are changing, and traditional television is still declining in popularity, while consumption of live or recorded streamed content is increasing. Often, the content generators for these live streams operate independently, without live production support. Today's solutions for live stream enhancement are limited to closed captioning, or otherwise require active input from the performer or production team during the stream. Closed captioning can be provided by live people-based services, automatically generated during a stream using speech recognition technology, or read from a pre-defined closed captioning file and synchronized to the stream.

### SUMMARY

An embodiment optimizes live streams by annotating a script with markers for a live stream event. The embodiment defines an element within the live stream event. The embodiment defines a performance milestone within the element. The embodiment associates a first action with the performance milestone. The embodiment constructs a trigger within the script. The embodiment associates the trigger with a corresponding second action. The embodiment monitors the live stream event for the performance milestone and actuates the first action in response to the performance milestone. The embodiment monitors the live stream event for the trigger and actuates the second action in response to the trigger. The first and second action are real time changes to the live stream event.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of the logic overview in accordance with an illustrative embodiment;

FIG. 3A depicts a block diagram of an example live stream event with optimization in accordance with an illustrative embodiment;

FIG. 3B depicts the continuation of the block diagram in FIG. 3A, an example live stream event with optimization in accordance with an illustrative embodiment;

FIG. 4A depicts a flowchart of an example of the onboarding process for a live stream event in accordance with an illustrative embodiment;

FIG. 4B depicts the continuation of the flowchart in FIG. 4A, an example of the onboarding process for a live stream event in accordance with an illustrative embodiment;

FIG. 5 depicts a flowchart of an example of the process for defining, onboarding, and storing the triggers which are to be monitored for during a live stream event in accordance with an illustrative embodiment;

FIG. 6 depicts a flowchart of an example of the process for defining, onboarding, and storing the actions to be executed during a live stream event in accordance with an illustrative embodiment;

FIG. 7 depicts a flowchart of an example of the process for associating the triggers with actions in accordance with an illustrative embodiment;

FIG. 8 depicts a flowchart of an example of the process for associating performance milestones with actions that apply to a specific element in accordance with an illustrative embodiment;

FIG. 9 depicts a flowchart of an example of entering onboarding information into the computer implemented in accordance with an illustrative embodiment;

FIG. 10 depicts a flowchart of an example of monitoring the live stream event and identifying the location of the stream in the script or active element in accordance with an illustrative embodiment;

FIG. 11 depicts a flowchart of an example of the process for synchronizing processing of the live stream event and active elements in accordance with an illustrative embodiment; and

FIG. 12 depicts a flowchart of an example of the process for identifying triggers during the live stream event in accordance with an illustrative embodiment;

FIG. 13 depicts a flowchart of an example of the process for identifying performance milestones during the live stream event in accordance with an illustrative embodiment; and

FIG. 14 depicts a flowchart of an example process for monitoring the live stream event to determine whether the end has occurred with an illustrative embodiment.

### DETAILED DESCRIPTION

Live streaming has exploded in popularity as a source of content generation for entertainment, education, and other information sharing or social purposes. Everyone from individual musicians, video gamers, teachers, businesses, and schools are creating live stream events to reach current and new audiences. Often, the content generators for these live streams operate independently, without live production support. Today's solutions for automated live stream enhancement are limited to closed captioning, or otherwise require active input from the performer or production team during the stream. Closed captioning can be provided by live people-based services, automatically generated during a stream using speech recognition technology, or read from a pre-defined closed captioning file and synchronized to the stream.

A live streaming environment contemplated within the scope of the illustrative embodiments is significantly different from staged production of content where events are pre-planned, strict adherence happens to a pre-written and pre-planned script, and components and peripherals involved in the staged production are preconfigured to perform certain operations in response to timing and/or predefined events transpiring in the staged production environment. In a live streaming environment contemplated in the illustrative embodiments, often there isn't a strict script, just an expectation of a flow of events, which may or may not actually follow the expectation. Consequently, even if a script exists for the streaming, adherence to the script is not reliable for preprogramming any components or preconfiguring certain operations at any peripherals. In other words, a live streaming environment of the illustrative embodiments is a dynamic environment, where events can be expected but their timing, their form, certainty of their occurrence at all, availability during the streaming are not guaranteed. The environment of the illustrative embodiments is regarded as dynamic because the events contemplated within the scope of the illustrative embodiments in that environment of the illustrative embodiments are in some respect related to the live, ad hoc, and dynamic aspect of the streaming, i.e., contextual to the content, subject, location, circumstances, a cause, or an effect of the live streaming, but are not predetermined and not preconfigured.

Live stream enhancements contemplated within the scope of the illustrative embodiments include dynamic event-based changes in the configuration of a peripheral device local to the streamer, such as by non-limiting example, changing the active camera, changing the lighting settings, or changing the microphone or audio settings. In illustrative embodiments, dynamic event-based changes can also be made in the configuration of a peripheral device remote to the streamer such as, by non-limiting example, changing the data storage type, quality, or duration of the live stream event; changings stream settings at a server, such as from a restricted view to open to public or vice versa; causing a server to send out invitations to the stream; causing a server to divert the stream to a different streaming channel. In other embodiments dynamic event-based changes can be made to the stream itself such as by non-limiting example, background changes, overlays to the video, changes in audio, dynamic event-based change of speed of activity being streamed. Changes in speed may include changing from actual motion speed to slow motion for a duration or insert a replay of a clip of the stream before continuing with live stream again, inserting into the stream content sourced from outside the site of the live production. In illustrative embodiments dynamic event-based changes can also be made to devices local to the audience such as, by non-limiting example, smart devices, speakers, lights, and other electronic devices that may be in the same physical space as the viewer.

The illustrative embodiments recognize that while some of these features can be made available in pre-programmed and pre-configured staged production settings as well as in pre-packaged gameplay environments, providing these features for live streaming environments is difficult due to the high degree of variability—dynamic nature—of the live streaming environments. The illustrative embodiments recognize that presently available solutions for live streaming do not provide an independent content producer (“the streamer”) with a way to optimize the management of local peripherals or stream enhancements during the live stream beyond closed captioning.

Therefore, there exists a need for an automated optimization method and system for live stream events that allow individual users to operate independently without the need for a production support team, enabling higher quality relative to the quality possible with manual adjustment to a limited set of peripherals streams for less cost. Various embodiments of this system and method could be implemented in any live streaming platform and has use cases across many stream types. Various embodiments of this system and method could include but are not limited to live plays, live sing-alongs, live concerts, live classes and seminars, and live gaming. Implementations of this system and method could also extend to recorded stream performances.

Embodiments disclosed herein describe the optimization of a live video stream event such as a musical performance; however, use of this example is not intended to be limiting but is instead used for descriptive purposes only. Instead, the method can be used for any event that may be streamed over a computer network to one or more viewers. The method may include a pre-written script in some embodiments. In other embodiments, the script may include key milestones and events expected to occur during the live stream event.

Also, the term “annotate” as referred to herein may include adding markers to a script. The annotations may cause defined actions to occur when the marker, event, or trigger has occurred. Based on the markers, stream enhancements may be executed on an ad-hoc basis or at known points during the performance. The markers can be analyzed to allow predictive-based enhancements in the future.

The present disclosure addresses the deficiencies described above by providing by non-limiting example a process, a system, method, machine-readable medium, that allows individual users to automate production of live stream events. The production assistance can be preloaded into the system by annotating a script with markers describing dynamic events (“triggers”) or key parts of the performance timeline (“performance milestones”) and executing actions in response to the dynamic events or reaching part of the performance. The optimization can also include ad hoc and predictive actions to be executed through machine learning techniques. Data from one live stream production can be used to coordinate and execute actions in responses to events and milestones in future live stream events. Disclosed embodiments combine annotating scripts, associating triggers/events with actions, and performance milestones with actions to establish a stream definition and monitoring a stream in progress using the stream definition, to identify triggers and performance milestones as they occur, and execute associated actions for local or stream enhancements.

The illustrative embodiments provide for automated optimization of live stream productions. A trigger as referred to herein is a define events that may occur at any time during a live stream event. The triggers may be detected by peripheral devices such as by non-limiting example, cameras, microphones, instruments, touchscreens, motion sensors, keyboards, mouse. Triggers may include but are not limited to streamer motions or gestures detected by a camera or motion sensing device. Such as, by non-limiting example looking at a particular camera, waving a hand, or standing up. Triggers may also include audio detected by a microphone or other audio sensing device. Such as by non-limiting example, a streamer may say “change background,” the streamer may begin singing the chorus of a song, a particular melody may be player on an instrument, or a particular audio recording may be played by the streamer.

Triggers may include other input detected by the peripheral device such as by non-limiting example, touch screen, keyboard, or a mouse. Trigger may also be defined as combinations of distinct observed events from a group of events. For example, a streamer may say “please stand” and also stands up. A subset of observed events from a grouping of events may also be a trigger. For example, any two observed events from a collection of five events may be coded as a trigger. Triggers may also include using Boolean logic constructs. Such as by non-limiting example, when a streamer says “please stand” AND the streamer stands up OR the streamer raises the streamers hand up a trigger may be detected. In one embodiment triggers may include recording events through the peripherals of the streaming computer system such as, by non-limiting example, a webcam may be used to capture a gesture of the raising of the hands of the streamer.

In another embodiment, a trigger may be initiated by a member of a live stream audience such as by non-limiting example, a viewer “liking” a stream, sending an emoji, saying a keyword in a chat, or sending a tip or payment may be a trigger. A trigger during the live stream can be of many different modes including, but limited to, a sound, a movement by the live streamer, input from a peripheral device, manipulation from a peripheral device. In some embodiments triggers may be referred to as multimodal events to be monitored during a stream. As referred to herein multimodal events means that that the triggers may be more than one type of communication such as an audible event, a physical event such as by non-limiting example standing, a gesture, a change in the light, and other ways to communicate that is capable of being sensed by another. A trigger may include but is not limited to sound, streamer movement, input peripheral manipulation, video analysis including motion analysis, object tracking, object identification and other events that may occur during a production or a recording.

A performance milestone as referred to herein is a key point within the live stream where the stream has a known structure. A performance milestone may include, by non-limiting example, key points within a stream script or storyline that are known in advance to potentially occur during the live streaming event. In many embodiments, a speech component or script of a live stream event may be known in advance of the event. In illustrative embodiments, scripts may be part of musical performances, sing-a-longs, newscasts, speeches, storytelling, plays, or other types of acting such as stand-up comedy shows. In such embodiments, a written script may be used to establish performance milestones for the live streaming event. A written script may allow particular peripheral devices to be engaged and the stream to be enhanced when the streamer reaches a particular part of the script. Such as, by non-limiting, example, the background of a live streaming event may be changed when a performer reaches a chorus of a song.

Although, in some embodiments performance milestones may be defined as specific sections of a written script, in other embodiments, the concept of performance milestones can generally by described as a specific part of the stream that is known to occur in advance. This may include, by non-limiting example, a known part of a video to be displayed allowing peripheral devices to be engaged and the live streaming event to be enhanced when a video game streamer reaches a particular part of a game. As a further example, when a game has a specific storyline, it may be known in advance that the gamer will reach a certain destination or meet a certain character at some point during the game. Meeting the destination or character would be a performance milestone.

An action as described herein may include both a local change of a peripheral device and a stream enhancement. An action may include but is not limited to adjusting lighting, changing which camera is active, overlay text/audio, change streamer background, and the changes that enhance the live stream event. Actions may also include light settings, such as brightness, color or turning on/off; camera settings such as switch active camera and zoom or pan; microphone settings such as sensitivity, volume, mute, changing the active microphone; instrument settings such as volume, tone, pickup selector, bass, mid, treble, gain, reverb, distortion, special effects, configurations; and screen settings such as change layout, turning on or off and show other content. Actions may further include overlay of audio or music, overlay of video on a portion of the stream such as, by non-limiting example, text, images, motion video; changes to the stream background, addition of subtitles, and volume control. Actions may occur locally to the streamer. As referred to herein local means in the production area of the streamer—not necessarily their computer or the closest device. For example, when a change is made locally to the streamer, the change is made to the configuration of a peripheral device, such as a camera or light, that is within the production area of the streamer. When an action is remote to streamer as described herein, the change happens on a device away from the streamer. For example, remote would be manipulating the lighting in the viewer's room. Dimming the light in the viewer's room is remote to the streamer who is in a different location than the viewer. In some embodiments, the actions may occur remotely to the streamer but locally to one or more viewers of the live stream event.

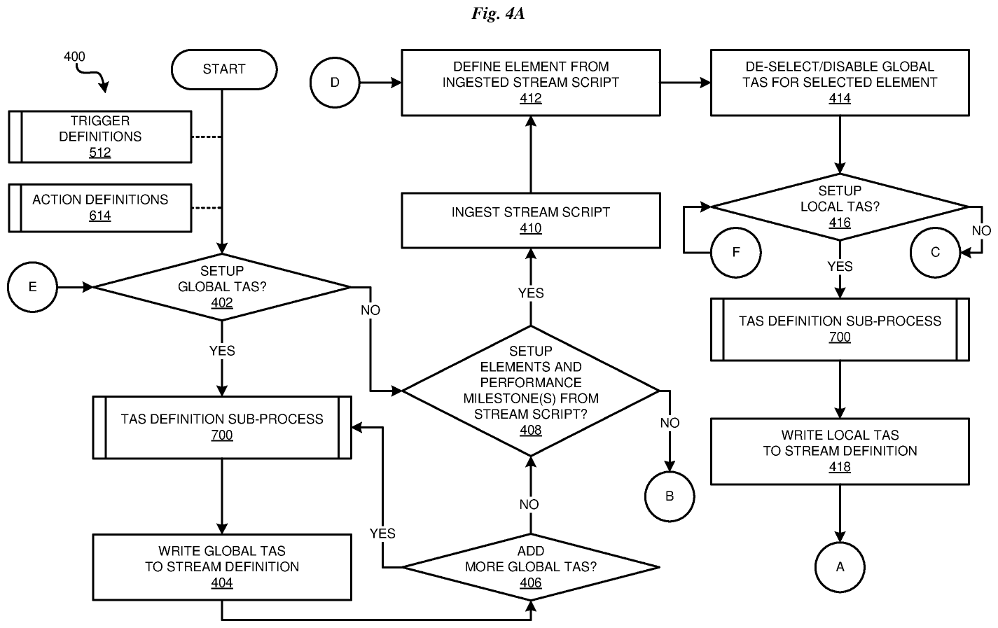

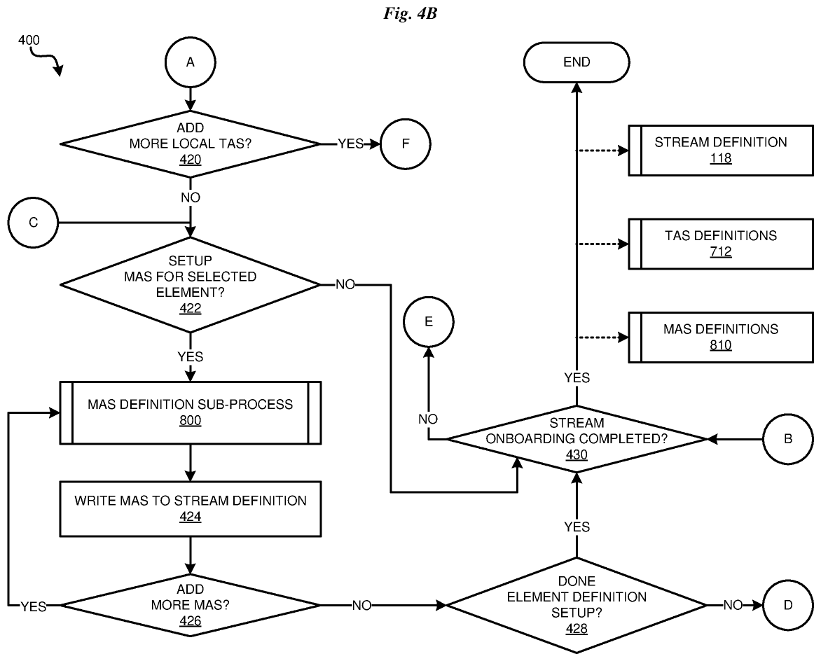

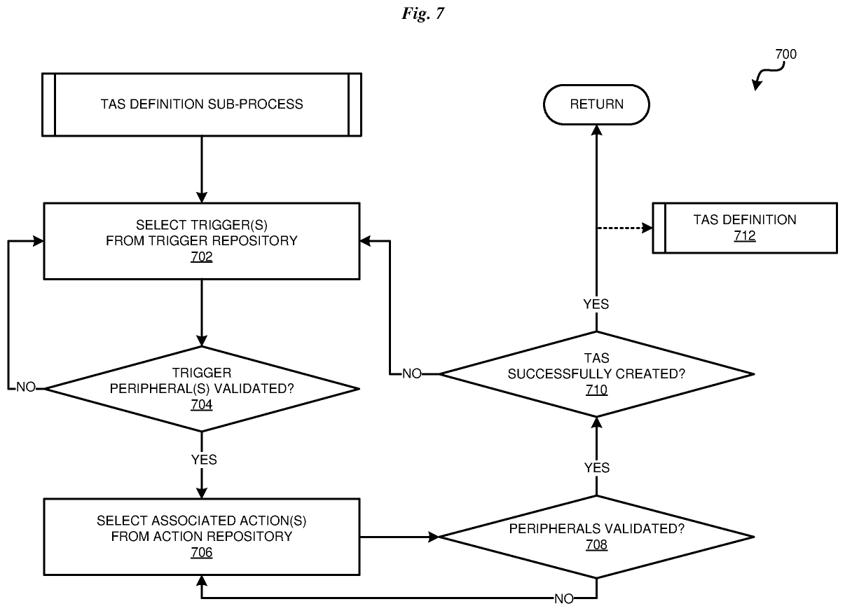

As described herein, a Trigger Action Set (TAS) defines a combination of one or more pre-defined triggers to one or more pre-defined actions as will be described in more detail in FIG. 7. To create a TAS, the user may select one or a combination of triggers from a repository of trigger definitions and associate their selection to one or more actions from a repository of action definitions. In some embodiments, the combination of triggers used to form a TAS may be a combination of multiple distinct triggers, a subset of observed triggers from a grouping of triggers or defined using Boolean logic constructs. For example, a TAS may be created so that every time a user plays the G chord (trigger) and shouts “clap” (trigger) a clapping emoji is displayed to the screen of the viewers or audience (action) and the lights flash (action). In another embodiment, a TAS may define period of time within which the multiple triggers must occur for the TAS to be triggered. Such as in the clapping example, the TAS would only be triggered if the “clap” trigger occurred within 3 seconds of the G chord trigger. In another embodiment, TAS are pre-defined, and the user or streamer can select from a repository of TAS during the stream onboarding process. In yet another embodiment, the user may define TAS during the stream onboarding process (FIG. 4A) by entering a TAS definition sub-process (FIG. 7). In both examples of embodiments, the TAS selected during the stream onboarding process are written into the stream definition. TAS may be enabled globally for the stream, meaning they are active for all elements in the stream and are considered global (TAS). In other embodiments, TAS may be enabled locally and associated with a single or set of stream elements and they are considered local TAS. In some embodiments, the definition of an active local TAS will override an active global TAS if both local and global have the same triggers and are associated with the same element. If a local TAS is not defined, the global TAS will be considered active. An element, as will be described later, may have multiple active global TASs and local TASs.

An element as described herein are pre-defined sub-components of a live stream event which may occur during the live stream event. In one embodiment, elements may be defined as a section of the stream script, which is known in advance, such as, by non-limiting example, a play may define separate elements for each act, or a music performance may define an element for each set. In another embodiment, elements can be defined as portions of a live stream event that may or may not occur in order, such as, by non-limiting example, a musician may define an element for each song in the musician's repertoire and may choose which song to play during the live stream based on audience requests. The definition of an element provides a logical section of the performance to which Trigger Action Sets (TAS) and Milestone Action Sets (MAS) can be associated. An element is not restricted to being a continuous block of the script but may be a reference to distinct parts of the script with the same active TAS and MAS. A TAS explicitly associated with an element is considered a Local TAS. In an embodiment for TAS, a performer may define two TASs which use the same trigger such as “wave hand” but have a different action such as “display background A” vs. “display background B”. Depending on the element which is being performed, such as a song, a different TAS will be active. Therefore, the background which is displayed can vary by song even though the action of waving the hand is the same.

In some embodiments, if a local TAS is not defined, then any defined global TAS would be active during the element. In other embodiments, global TASs may be active or not active during the element. In an embodiment including a Milestone Action Set (MAS), which will be described later, an element may be defined for the chorus of a song and a MAS may be defined for a key lyric. In an embodiment, when a performer sings the lyric, the performance milestone is identified, and an action, such as lighting change, occurs automatically. In embodiments where individual elements are not defined for the stream, the entire steam is considered to be a single default element. In some embodiments any part of the performance not covered by an explicit element defined is considered to be part of the default element and may therefore have a global TAS. In another embodiment, any part of the live stream event not covered by an explicit element definition will not have any active TASs, MASs, or both. A TAS and MAS may be used to establish a stream definition. A global (TAS) includes a set of triggers associated with actions that apply to the entire stream. A local TAS as referred to herein includes associating triggers with actions that apply to a specific element. Onboarding as referred to herein includes defining each of the triggers, actions, global trigger-action-set, element definition, local trigger-action set, and milestone action set definition for the intended live stream production.

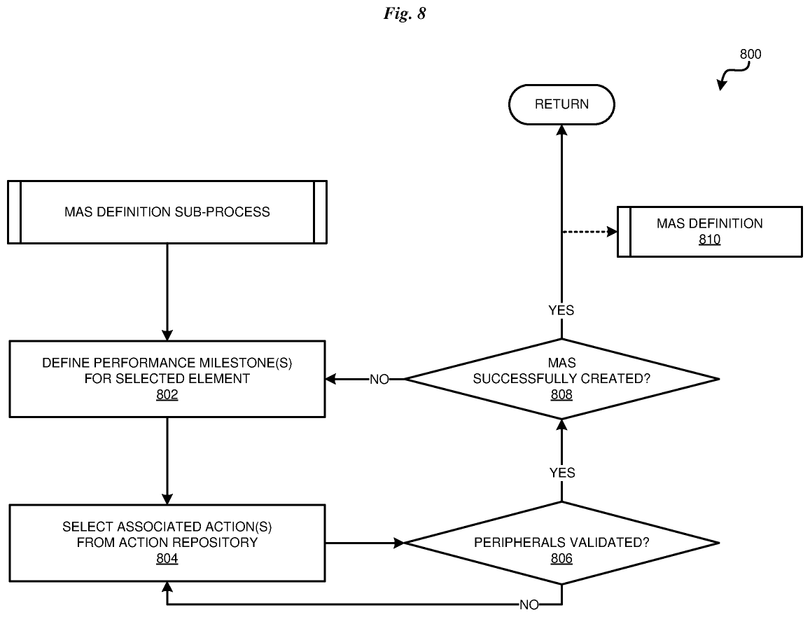

A Milestone Action Set (MAS) as referred to herein is the combination of one or more pre-defined performance milestones to one or more pre-defined actions. To create a MAS, the user selects one or more performance milestones from a selected element and associates the selection to one or more actions from a library of actions. For example, a MAS is created so that every time a user enters the third verse of a poem, the lights dim, and a sound of birds is played. In some embodiments, the combination of performance milestones used to form a MAS may be a combination of multiple distinct performance milestones, a subset of observed performance milestones from a grouping of performance milestones or may be defined using Boolean logic constructs. Such as, by non-limiting example, the same action may be associated with multiple performance milestones such as Performance Milestone 1 OR Performance Milestone 2 OR Performance Milestone 3. In some embodiments, timing between performance milestones may be considered. In this example, a song may be played slowly, or quickly, and different actions and therefore stream effects may be executed based on the timing between performance milestones, for example Performance Milestone 1 AND Performance Milestone 2 AND Time<5 seconds. In one embodiment MAS are pre-defined and the user can select from a repository of MAS during the stream Onboarding process which will be described further in FIG. 4B). In another embodiment, the user defines MAS during the stream onboarding process by entering the MAS definition sub-process which will be described further in FIG. 8. In both cases, the MAS selected during the stream onboarding process are written to the stream definition as illustrated in FIGS. 4A and 4B.

Optimal Live Stream Management System (OLMS) as referred to herein may include a software product that executes on the streaming computer system, on a cloud provided service which may be either provided as a third-party application or as part of a streaming platform, or a combination of both. The OLMS is comprised of the following building blocks: trigger definitions, performance milestone definitions, action definitions, Trigger Action Sets (TAS), elements, Milestone Action Set (MAS), live stream event, monitoring and synch module, local enhancement module, and stream enhancement module. Once onboarding has been completed, the method for an illustrative embodiment of an Optimal Live Stream Management System (OLSMS) may include setup, stream element definition identification, stream synchronization, trigger identification, performance milestone identification, and end of stream monitoring. As described herein setup may include configuring data for the stream. The data may be ingested and validated by the user and system. As part of set up, peripheral devices may be validated to function, and initial values may be set. Stream element identification as referred to herein may include the use of Natural Language Processing (NLP) or analysis of audio within the stream to monitor the stream and identify what element the stream is in. Analysis of the audio may include music, a speaker, and the like. The element of the stream may include what song is playing or another part of the stream. Stream synchronization as referred to herein may include synchronizing processing of the stream with the active element and identifying and storing any upcoming performance milestones. Trigger identification as referred to herein includes identifying triggers or events by monitoring the audio, video, and other signal inputs from peripheral devices and executing the actions associated with the triggers. Performance milestone identification as referred to herein includes identifying performance milestones by monitoring the audio, video, and other signal inputs from the peripheral devices and executing the actions associated with the performance milestones. Throughout the stream, an End of Stream monitoring process may be continuously running to determine whether the stream has ended. In various embodiments, monitoring for the presence or end of triggers and events also occurs.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures, therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

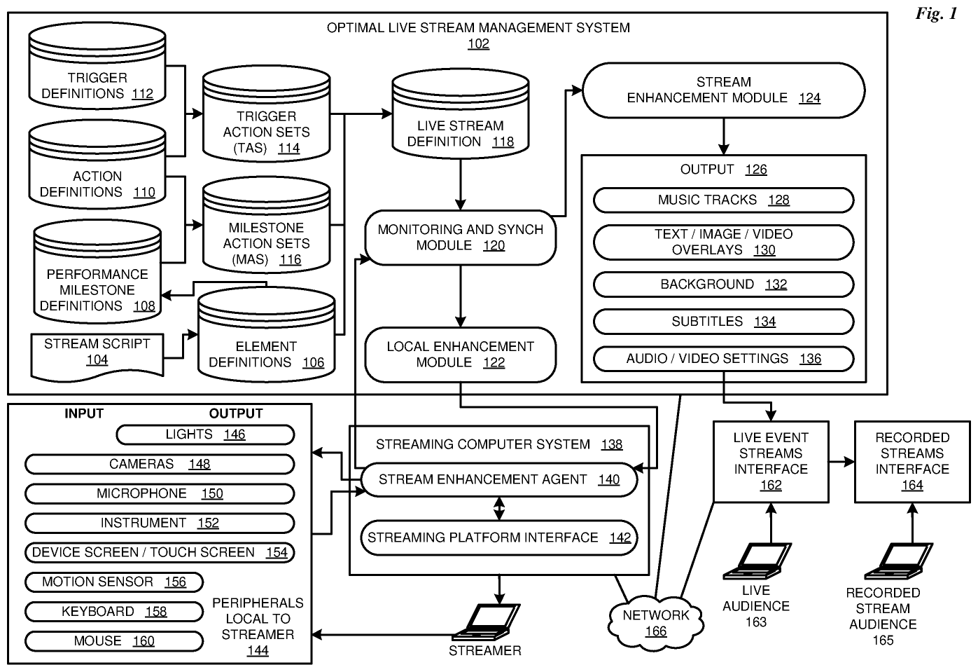

With reference to FIG. 1, this figure depicts a block diagram of a computing environment 100. Computing environment 100 contains an example of an environment for the execution of at least some of the computer code involved in performing the inventive methods, such as an optimal live stream management system 102 that provides definitions of triggers 112, actions 110, performance milestones 108, and elements 106. Triggers 112 are associated with actions 110 to form trigger action sets (TAS) 114. Elements 106 are pre-defined sub-components of a streamed live event which may occur during the live stream. In one embodiment, elements can be defined as a section of the stream script 104. Each element 106 may have associated performance milestones 108. Performance milestones 108 are associated with actions 110 to form Milestone Action Sets (MAS) 116.

The Live Stream Definition 118 captures all relevant components required for the Optimal Live Stream Management System 102 to function for a given stream. These may include element definitions 106, the stream script 104, Triggers Actions Sets (TAS) 114 references (global and/or local), and Milestone Action Set (MAS) 116 references. Based upon the selections by the user, one or more of these components may be present in the live stream definition 118. In an embodiment, the live stream definition 118 is a performance script annotated with markers. In this embodiment, a lexicon of marker types is used to annotate a performance script. Marker types may include markers defining stream Elements 106, and markers referencing Local Trigger Action Sets and global Trigger Action Sets (TAS) 114, and Milestone Action Sets (MAS) 116. Markers may use the format of existing annotation languages such as XML (Extensible Markup Language) or JSON (JavaScript Object Notation) or may use a proprietary method to annotate a performance script. In other embodiments, the live steam definition 118 is a database which tracks active components for a given stream, or some other logical construct which can be consumed by the OLMS monitoring and synchronization module 120.

The live stream management system 102 allows a user to annotate a script 104 with markers representing elements 106, TAS 114 and MAS 116 to form a live stream definition 118. During the live steam, the Monitoring and Synch Module (MSM) 120 is responsible for ongoing monitoring of the live stream in progress, by ingesting input from the various stream input peripherals devices 144 (either directly or via the Stream Enhancement Agent 140). The MSM 120 ingests the live stream definition 118 to identify active Elements 106, local and global Trigger Action Sets (TAS) 114, and Milestone Action Sets (MAS) 116 associated with the stream. In various embodiments, while monitoring the live stream, if a trigger associated with an active global TAS is identified, the associated action is evaluated and either the local enhancement module 122 or the stream enhancement module 124 is called to execute the action. Additionally, the MSM continually attempts to identify the active stream element. Once the active element is identified the stream is also monitored for active local triggers and performance milestones. While monitoring the live stream event, if a trigger associated with an active local TAS is identified or a performance milestone associated with an active MAS is identified, the associated action is evaluated and either the local enhancement module 122 or the stream enhancement module 124 is called to execute the action. The monitoring and synch module 120 may make use of artificial intelligence, machine learning, neural networks, deep learning, or other similar methods in order to monitor the audio, video and other inputs to identify triggers and performance milestones.

The Stream Enhancement Module (SEM) 124 is responsible for adjusting the audio and video content of the live stream event prior to its display on the live stream events interface 162, as defined by an action that is to be executed. Actions are executed as part of a Trigger Action Set (TAS) 114 or Milestone Action Set (MAS) 116, in response to an identified trigger or performance milestone. The SEM 124 can be considered to perform real-time stream editing using the outputs 126. As illustrated, the outputs may include music tracks 128, text/image/video overlays 130, background local to the streamer 132, subtitles 134, and audio/video settings 136. In various embodiments, the real time edits may include mixing of audio/music into the stream; applying text, image, or video overlays; changing the background; adding subtitles; adjusting audio output settings such as volume, treble, bass, pitch; adjusting video output settings such as quality, resolution, color balance, contrast, aspect ratio, sharpness, HDR (high dynamic range); adjusting any other settings than may manipulate the stream prior to its display on the live events streams interface.

The Local Enhancement Module (LEM) 122 is responsible for changing the configuration of peripherals local to the streamer as defined by an action that is to be executed. Actions are executed as part of a Trigger Action Set (TAS) 114 or Milestone Action Set (MAS) 116, in response to an identified trigger or performance milestone. The LEM 122 may interface with peripheral devices 144 via the stream enhancement agent 140 on the streaming computer system 138 or may interface with peripheral devices directly. In various embodiments, the LEM 122 may, for example: adjust or turn on/off lights 146; adjust the brightness, color or other light characteristics; switch active cameras 148; adjust camera settings such as zoom, pan, tilt; turn on/off/mute microphones 150/instruments 152; adjust microphone 150/instrument 152 settings such as treble, bass, volume; enable microphone/instrument effects such as echo, pitch-correction, reverb, delay; turn on/off displays local to the streamer; adjust what is shown on the display 154 local to the streamer; turn on/off and adjust settings for any other peripheral devices 144 local to the streamer.

In various embodiments a live stream may be referred to as a live stream production, a live stream event, a stream, a live stream, or other similar phrases including live and stream. The system is also able to analyze markers for predictive-based enhancements in the future. In addition to live stream management system 102, computing environment 100 includes, for example, a streaming computer system 138, a network module 166 including a wide area network (WAN), end user devices (EUD), collectively, are available both for a live audience 163 and a recorded stream audience 165 as illustrated. In embodiments, end user devices 163 and 165 may be systems that display the live or recorded stream to a large audience, such as on a large screen in a theatre, stadium, concert hall, and the like. In this embodiment, peripheral devices are connected locally to the streamer and include lights 146, cameras 148, microphones 150, instruments 152, devices with screen and touch screens 154, motion sensors 156, keyboards 158, and one or more mouse 160. The system 100 also includes live stream interfaces 162. The live stream events interface 162 is the publicly or privately available interface where the live stream audience may watch the live streaming events. Live streaming events may include, but are not limited to plays/performances, sing-a-longs, concerts, stand-up comedy, and gaming.

The audience may access the live stream event via software such as a web browser or app on a mobile device or smart television. In various embodiments, the live stream interface may allow live audiences to view the live stream event through personal devices including but not limited to laptops, mobile phones, tablet computers and other similar devices. The system as illustrated also includes recorded stream interfaces 164. The recorded streams interface 164 is the publicly or privately available interface where the recorded streams audience may watch previously recorded live streaming events. As previously described, live streaming events may include, but are not limited to plays/performances, sing-a-longs, concerts, stand-up comedy, and gaming. Once a live stream is recorded, postproduction editing may occur in some embodiments prior to posting to the recorded streams interface. The audience may access the recorded streams via software such as a web browser or app on a mobile device. The recorded stream interface may allow audiences to access the content of the live stream at different times. The recorded stream audience may access the recordings through personal devices including but not limited to desktops, laptops, mobile phones, and tablet computers. In various embodiments, the live stream events interface 162 and the recorded streams interface 164 may include components such as a display screen, speaker, microphone, wearable devices (such as goggles and smart watches), keyboard, mouse, printer, touchpad, game controllers, and haptic devices.

In various embodiments, the concepts of a LEM 122 and SEM 124 can be extended to include a Remote Enhancement Module (REM) that would manipulate peripherals local to the streaming audience where local means in the same physical spaces as the live streaming audience or recorded stream audience. This may include, for example, manipulation of lighting and audio settings within a venue where an audience is gathered such as by non-limiting example, a stadium or a concert hall, as an action that is executed. In a further example, this may include manipulation of peripherals individually owned by audience members such as smart devices, speakers, or lights. In this example, audience members may register and validate their devices for participation in the stream, and therefore receive a more immersive experience that is orchestrated by the streamer.

In another embodiment, the concepts of a LEM 122 and SEM 124 can be extended to include an integration module that would interface with other third-party services. This may include, by non-limiting example, payment services, other streaming platforms, cryptocurrency platforms, or data storage platforms. Continuing this example embodiment, an executed action may allow a streamer to accept a payment, and automatically upload a clip of the recent performance to a viewer's data storage service.

In still another embodiment, the OLMS can leverage the constructed metadata model for learning-based improvements in future streams. In this embodiment, a predictive enhancement module may analyze markers in a stream definition for predictive-based enhancements of stream definitions in the future. By non-limiting example, a steamer may define a performance milestone at the beginning of the chorus of a song, and an associated MAS to change the background of the stream to a particular image with the song name and “chorus” in the file name (e.g., “LeavingOnAJetPlane_chorus.jpg”). The OLMS may determine that the streamer intends to use file names of this format to change the background at the performance milestone that defines the start of the chorus of the performance. Therefore, the OLMS may predict that for future performances, a MAS should be proposed to the streamer to change the background for the chorus of a song in a similar way.

In another embodiment, the OLMS may leverage integrations with Internet query engines, music metadata providers, or artificial intelligence services such as, by non-limiting example, IBM Watson® or ChatGPT®, (IBM Watson and ChatGPT are trademarks owned by their respective owners in the United States and other countries) to identify the chorus of a song and predictively propose the performance milestone, action and the MAS to be included in the live stream definition 118 for a future performance. In another example, a gaming streamer may define a performance milestone, action, and MAS to overlay the text “The Boss!” on the stream when encountering a boss character in a video game. The OLMS may determine that the streamer intends to overlay “The Boss!” whenever a boss character is encountered in any video game the streamer is playing. Therefore, the OLMS may predict that for future performances, a MAS should be proposed to the streamer to overlay “The Boss!” on the stream anytime a boss character is encountered.

In an embodiment, the OLMS may leverage integrations with Internet query engines, video game metadata providers, or artificial intelligence services to identify boss characters in various video games and predictively propose the performance milestone, action, and MAS to be included in the stream definition for a future performance. Such predictive enhancements can be extended to all attributes of the stream definition, including elements 106, triggers 112, performance milestones 108, local Trigger Action Sets (TAS) 114, global TAS 114, and Milestone Action Sets (MAS) 116. Such predictive enhancements may be proposed to the streamer during the onboarding process. The streamer may confirm or deny the predictive enhancements to be applied to a given stream. In the described examples, the predictive enhancements are based upon the prior stream definitions of the same streamer.

In another embodiment, the predictive enhancements may be based upon stream definitions defined by other streamers using the OLMS. Enhancements may be proposed by the OLMS analyzing a plurality of stream definitions from the total population of streams from all users of the system, or a subset of streamers based on various criteria such as age of the streamer, the type of stream, such as, by non-limiting example, music, comedy, gaming, or a lecture, the topic of the steam, such as by non-limiting example, defined or derived from stream analysis, the location of the streamer, the language spoken by the streamer, the type of peripherals used by the streamer, the integrations used by the streamer, and other criteria that could be used.

STREAMING COMPUTER SYSTEM 138 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 138, to keep the presentation as simple as possible. The steamer may access the streaming platform, such as by non-limiting example YouTube®, Twitch®, Facebook®, Vimeo®, Watson Media®, and many other companies that provide video streaming services online (YouTube, Twitch, Facebook, Vimeo, Watson Media are trademarks owned by their respective owners in the United States and other countries) through streaming platform interface software 142 such as by non-limiting example, a web browser or a third party software, installed on the streaming computer system 138. The streaming computer system interfaces with one or more peripherals 144 local to the streamer. In one embodiment, the streaming computer system 138 has a locally installed Stream Enhancement Agent 140. In this example embodiment, all interaction with peripherals 144 is coordinated by the Stream Enhancement Agent 140. The Stream Enhancement Agent 140 also interfaces with the Monitoring & Synchronization Module 120 and Local Enhancement Module 122 of the Optimal Live Stream Management System 102. In another embodiment, peripherals may directly interface with the Monitoring & Synchronization Module 120, the Local Enhancement Module 122, or the streamer computer system 138. This may be the case where peripherals support standardized interfaces or communication protocols supported by the Optimal Live Stream Management System 102 or streaming computer system 138. Computer 138 may be located in a cloud, even though it is not shown in a cloud in FIG. 1. On the other hand, computer 138 is not required to be in a cloud except to any extent as may be affirmatively indicated.

PROCESSOR SET includes one, or more, computer processors of any type now known or to be developed in the future. Processing circuitry may be distributed over multiple packages, for example, multiple, coordinated integrated circuit chips. Processing circuitry may implement multiple processor threads and/or multiple processor cores. Cache is memory that is located in the processor chip package(s) and is typically used for data or code that should be available for rapid access by the threads or cores running on processor set. Cache memories are typically organized into multiple levels depending upon relative proximity to the processing circuitry. Alternatively, some, or all, of the cache for the processor set may be located “off chip.” In some computing environments, processor set may be designed for working with qubits and performing quantum computing.

Computer readable program instructions are typically loaded onto computer 138 to cause a series of operational steps to be performed by processor set of computers 138 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache and the other storage media discussed below. The program instructions, and associated data, are accessed by processor set to control and direct performance of the inventive methods. In computing environment 100, at least some of the instructions for performing the inventive methods may be stored in network management module in persistent storage.

COMMUNICATION FABRIC is the signal conduction path that allows the various components of computer to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY is any type of volatile memory now known or to be developed in the future. Examples include dynamic type random access memory (RAM) or static type RAM. Typically, volatile memory is characterized by random access, but this is not required unless affirmatively indicated. In computer 138, the volatile memory is located in a single package and is internal to computer 138, but, alternatively or additionally, the volatile memory may be distributed over multiple packages and/or located externally with respect to computer.

PERSISTENT STORAGE is any form of non-volatile storage for computers that is now known or to be developed in the future. The non-volatility of this storage means that the stored data is maintained regardless of whether power is being supplied to computer 138 and/or directly to persistent storage. Persistent storage may be a read only memory (ROM), but typically at least a portion of the persistent storage allows writing of data, deletion of data and re-writing of data. Some familiar forms of persistent storage include magnetic disks and solid-state storage devices. Operating systems may take several forms, such as various known proprietary operating systems or open-source Portable Operating System Interface-type operating systems that employ a kernel. The code included in network management module typically includes at least some of the computer code involved in performing the inventive methods.

PERIPHERAL DEVICE SET 144 includes the set of peripheral devices of computer 138. Data communication connections between the peripheral devices and the other components of computer 138 may be implemented in various ways, such as Bluetooth connections, Near-Field Communication (NFC) connections, connections made by cables (such as universal serial bus (USB) type cables), insertion-type connections (for example, secure digital (SD) card), connections made through wired or wireless local area communication networks and even connections made through wide area networks such as the internet. Storage is external storage, such as an external hard drive, or insertable storage, such as an SD card. Storage may be persistent and/or volatile. In some embodiments, storage may take the form of a quantum computing storage device for storing data in the form of qubits. In embodiments where computer 138 is required to have a large amount of storage (for example, where computer 138 locally stores and manages a large database) then this storage may be provided by peripheral storage devices designed for storing very large amounts of data, such as a storage area network (SAN) that is shared by multiple, geographically distributed computers. In various embodiments the system may include, IoT sensor set is made up of sensors that can be used in Internet of Things applications. For example, one sensor may be a motion detector.

NETWORK MODULE 166 is the collection of computer software, hardware, and firmware that allows computer 138 to communicate with other computers through WAN. Network module 166 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 166 are performed on the same physical hardware device. In other embodiments (for example, embodiments that utilize software-defined networking (SDN)), the control functions and the forwarding functions of network module 166 are performed on physically separate devices, such that the control functions manage several different network hardware devices. Computer readable program instructions for performing the inventive methods can typically be downloaded to computer 138 from an external computer or external storage device through a network adapter card or network interface included in network module 166.

WAN is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

REMOTE SERVER is any computer system that serves at least some data and/or functionality to computer 138. Remote server may be controlled and used by the same entity that operates computer 138. Remote server represents the machine(s) that collect and store helpful and useful data for use by other computers, such as computer 138. For example, in a hypothetical case where computer 138 is designed and programmed to provide a recommendation based on historical data, then this historical data may be provided to computer 138 from remote database of remote server.

PUBLIC CLOUD is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud is performed by the computer hardware and/or software of cloud orchestration module. The computing resources provided by public cloud are typically implemented by virtual computing environments that run on various computers making up the computers of host physical machine set, which is the universe of physical computers in and/or available to public cloud. The virtual computing environments (VCEs) typically take the form of virtual machines from virtual machine set and/or containers from container set. It is understood that these VCEs may be stored as images and may be transferred among and between the various physical machine hosts, either as images or after instantiation of the VCE. Cloud orchestration module manages the transfer and storage of images, deploys new instantiations of VCEs and manages active instantiations of VCE deployments. Gateway is the collection of computer software, hardware, and firmware that allows public cloud to communicate through WAN.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD is similar to public cloud, except that the computing resources are only available for use by a single enterprise. While private cloud is depicted as being in communication with WAN, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud and private cloud are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

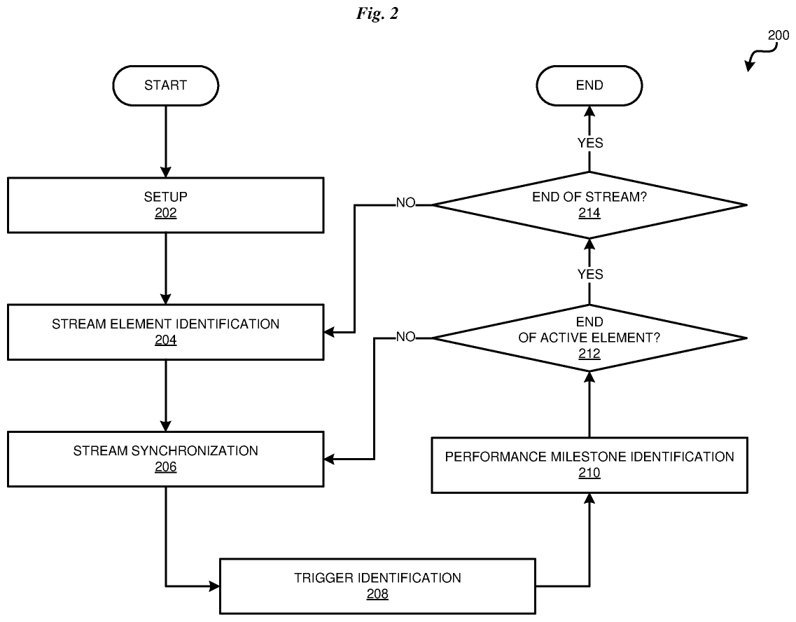

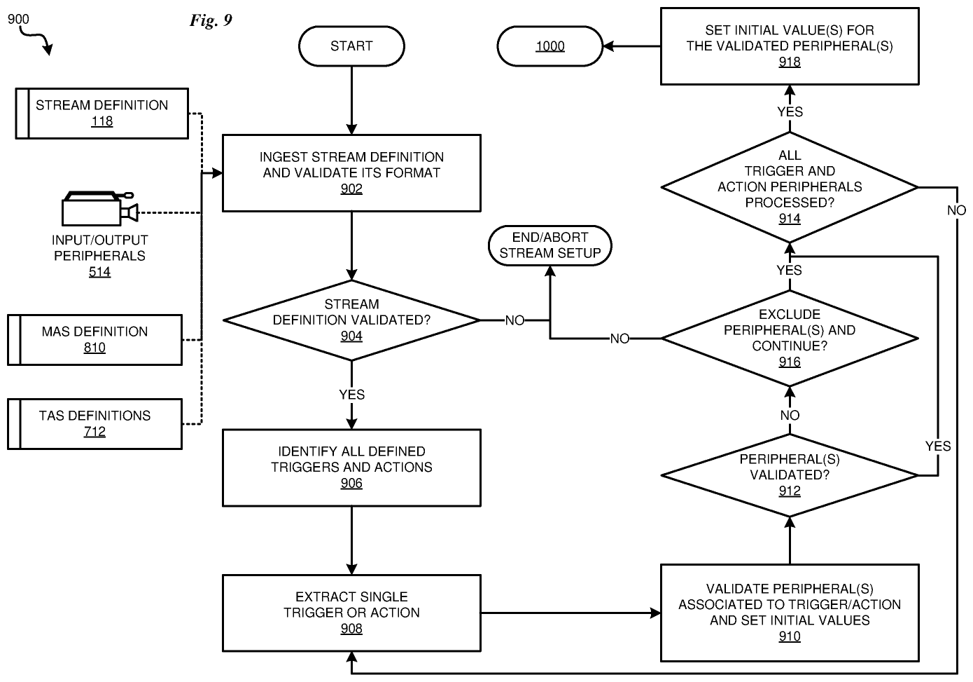

With reference to FIG. 2, this figure depicts a flowchart of an overview of an embodiment of a method for optimizing live stream production 200 in accordance with an illustrative embodiment. In the illustrated embodiment, the setup of optimization 202 includes ingesting the configuration from a stream definition 118, trigger action set (TAS) definition 114, and milestone action set (MAS) definition 116. Setup 202, which will be further described in FIG. 9, also includes extracting Triggers and actions from TAS 114 and MAS 116. Setup 202 also included validating peripheral devices 144 are functioning. During setup 202 the initial values for the peripheral device configurations are set. The configurations may include but are not limited to brightness levels of light, volume of audio including songs, speaker, and microphones. Once the setup is complete, the system waits for the stream to start.

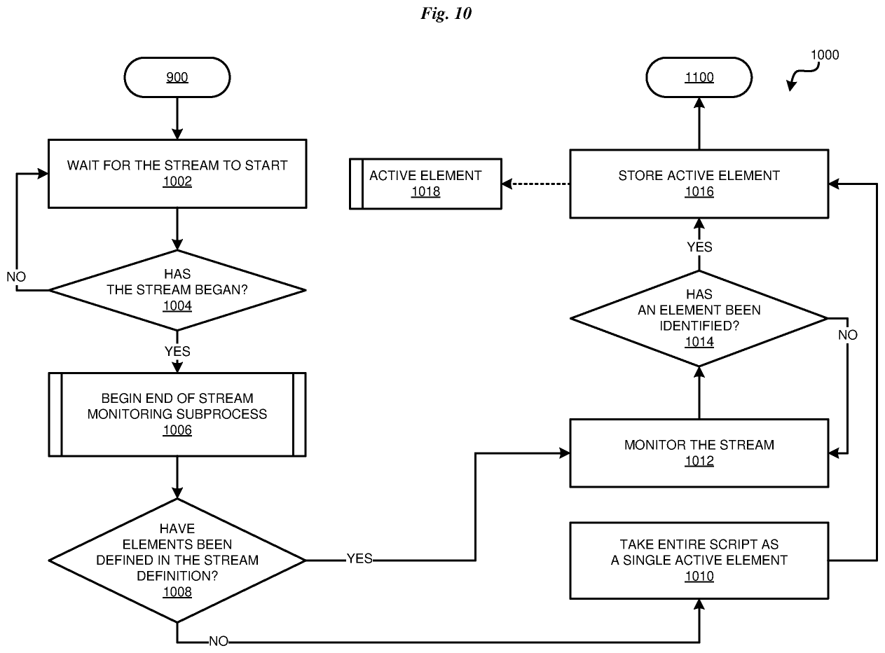

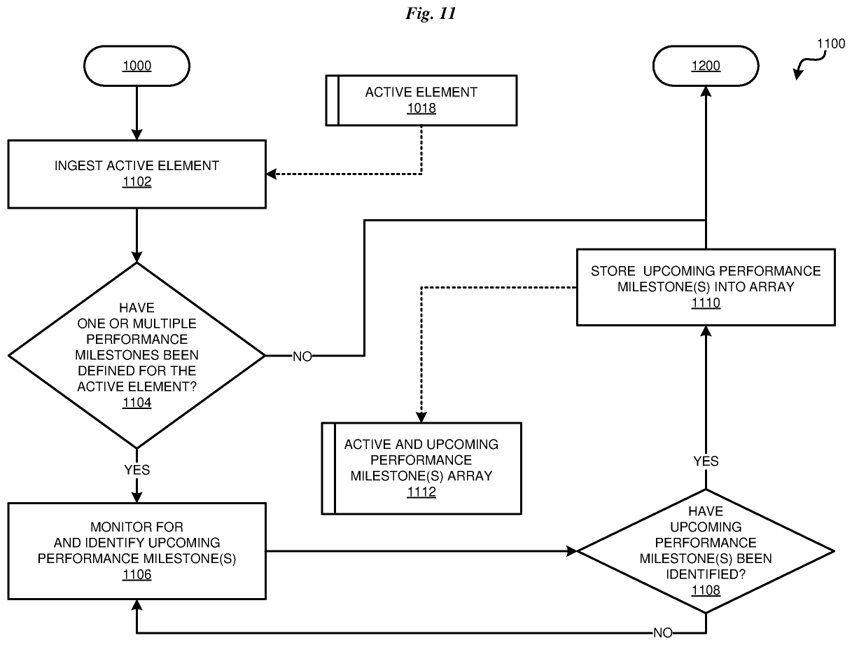

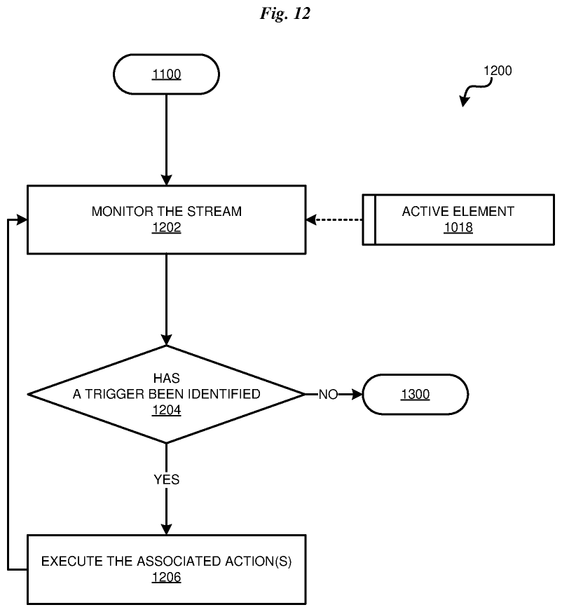

With reference to FIG. 2, stream element identification 204, which will be further described in FIG. 10, includes identifying the element of the live stream event such as what song, what part of the stream script, and other similar elements that may be a part or portion of the live stream production. Once the element is identified, an active element is the output provided to stream synchronization 206 and trigger identification 208 which will be described later in the disclosure. Stream synchronized will be further described in FIG. 11. Trigger Identification 208 will be further described in FIG. 12. A method may include starting a live video stream to be synchronized. The active element will be processed by the system to take further action.

Stream synchronization 206 uses the active element identified to synch to the current point in the live stream. In other words, stream synchronization matches the definition of the active element from the stream definition to the running live stream. During this process, stream synchronization keeps track of upcoming performance milestone based on the location or point in the active element in which the live stream is. The result of this process is the active and upcoming performance milestone(s) array.

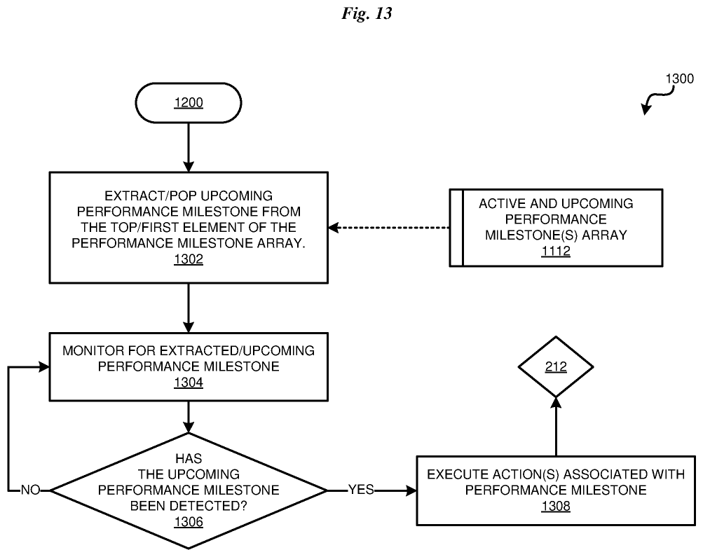

Trigger identification 208 identifies the triggers or events during the live stream that have been defined for the active element provided to the system. An embodiment of a computer implemented method for optimizing a live stream production includes generating one or more triggers/events to be monitored during a video stream. The method also includes identifying one or more actions to be associated with the trigger/event. The action may be performed in response to the trigger. Once a trigger has been identified for the active element, the respective TAS definition may be used to execute the actions associated with the trigger event. Performance milestone identification 210 is used to identify performance milestones during the live stream that have been defined by the active element. Performance milestone identification 210 will be described in more detail in FIG. 13. The method also includes identifying one or more milestones. The one or more milestones may include milestones known in a script for a live stream production. In various embodiments, the milestones may also include events known to occur during a live stream event. The known events may include but are not limited to the chorus of a song, meeting a boss in a video game, and similar situations. Active and upcoming performance milestone(s) array may be ingested by the process. The first upcoming performance milestone is extracted from that array to monitor the stream for the performance milestone. Once the performance milestone has been detected, the actions associated with the milestone are executed. The end of active element 212 decision checks whether the end of the active element has been reached. If the end of the active element has been reached the method moves on to the end of stream 214 decision. The method includes detecting whether one or more elements in the live stream are active. If the active element has not ended the method continues with stream synchronization 206 and proceeds through trigger identification 208 and performance milestone identification 210. The method also includes detecting whether the live stream is active. If the stream has ended 214, then the method concludes.

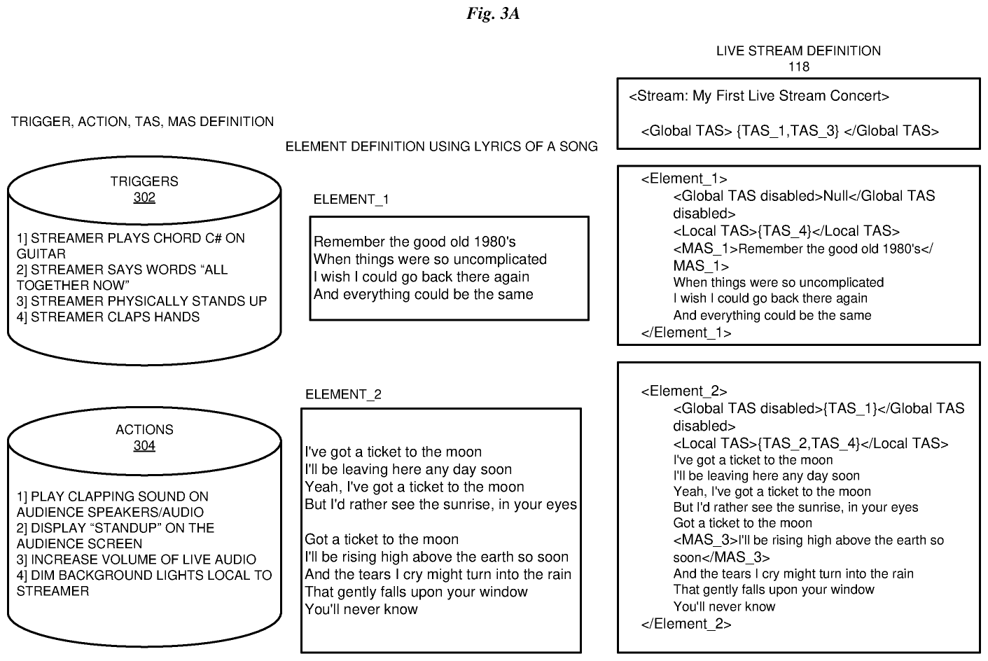

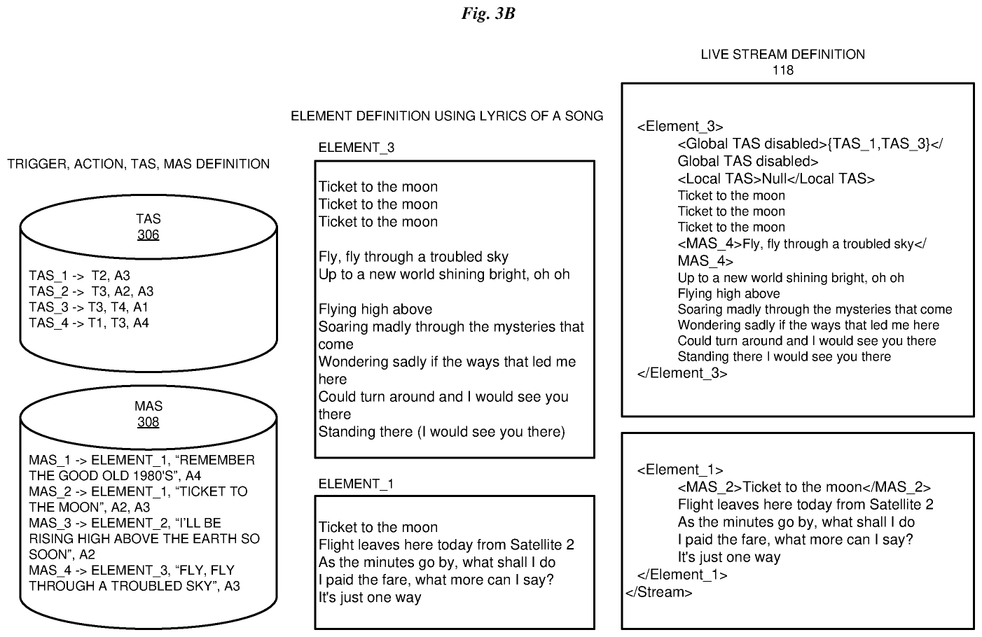

With reference to FIG. 3A and 3B, an example of an embodiment of an optimized live stream event 300 is illustrated. The example includes a live stream of a sing along. On the left of the figure the databases for the triggers 302, actions 304, trigger action sets 306, and milestone action sets 308 are illustrated. In the next column, the elements are defined as particular lyrics in the song to be sung. Referring particularly to element 1, an element is not restricted from being a continuous block of the script. Rather, an element is a reference to parts of the script with the same active TAS 306 and MAS 308. Referring now to the column on the right, the live stream definition 118, is illustrated combining the elements with the trigger events and associated events. As previously described a global Trigger Action Set (TAS) may be throughout the entire live stream production. Live stream definition 118 is one embodiment of the live stream definition 118 as previously described in reference to FIG. 1.

Another example of an embodiment of a method for optimizing a live stream production includes a lecture on human anatomy. Within the lecture script, the triggers are identified as the presenter saying the word “Poll” when the presenter says “Poll” a multiple-choice question appears on the screen for the viewers to participate in the poll. This simplifies the process for the presenter who would previously need to either move to the local computer to start the poll or ask an assistant to start the poll. The method described herein allows the presenter to add interactive portions into the lecture without needing to manually start the poll. Another action in this example includes the presenter holding a book in front of the presenter's face. This trigger starts the action of a link to purchase the books appearing on the live event stream interface 162 and 164 as illustrated in FIG. 1. Other trigger examples in an anatomy lecture may include the presenter asking if there are questions which causes the action of the live stream switching to a second camera. Another example is when the presenter says the phase “Anatomy came from the ancient Greek words” the words then appear on the screen as an overlay for viewers to see. As detailed above, optimization of a live stream event allows a single presenter to add numerous features to the live stream that previously would only be available with another person to assist or the presenter having to manually start each action during the lecture.

In reference to FIG. 4A and 4B, a flowchart of the onboarding process is illustrated. During the onboarding process a user may select pre-defined triggers 512 from a repository of triggers and match the triggers with specific actions 614 from the repository of actions. The process of defining trigger and associated actions generates a TAS 712 as described in FIG. 7. As previously described, a TAS 712 can be global meaning it is active throughout the entire live stream. The TAS 712 can also be local and active for specific sections of a script. A user can also provide a stream script during the onboarding process. The elements and performance milestones are defined from the stream script. Elements may be defined as part of the entire script such as, by non-limiting example, a song from a catalog. Elements may occur in any order during the live stream event. For each element defined, the user can select local TAS definitions to be active instead of the global TAS. In various embodiments, performance milestones may be defined during element definition. The performance milestones may also be matched with specific actions. The process of defining performance milestone and associated actions generates a Milestone Action Set (MAS) 810, as described in FIG. 8.

The method for onboarding starts and in step 402, the user selects whether to setup a global TAS. If yes, the user may set up a global TAS by entering the TAS definition sub-process 700. In another embodiment, the user can select a global TAS from a library of previously defined TAS's. If the user does not select to setup a global TAS, the method proceeds to 408 where the user selects whether to setup elements or performance milestones from a stream script. The TAS definition sub-process 700 will be described in further detail in FIG. 7. After the TAS definition sub-process the method for onboarding may include writing a global TAS to the stream definition 118 in step 404. The triggers with the selected associated action(s) create a trigger action set. The global TAS may then be written to the stream definition 118, and the method proceeds to 406. The stream definition 118 can exist in the form of a file, database, or other entity. Once the global TAS has been added to the stream definition, in 406, the user is asked whether they would like to add more global TAS's to the stream definition. If yes, they can start the process of adding a global TAS again, re-initiating the TAS definition sub-process 700 or if not, proceeding to 408. Once they decide to proceed, in 408 the user is asked whether they want to set up elements and performance milestones from a stream script. If yes, the method proceeds to 410 and user provides the stream script for ingestion. If the user does not want to set up elements and performance milestones, then the user proceeds to step 430 of the method.

In step 410, the user may provide the stream script that will be ingested in order to extract and setup performance milestones to be associated with actions and added to the stream definition file. The stream script might take various forms such as a script of lyrics, text, chords, a combination of these, or some alternative “stream script” input. Once a stream script has been ingested, the method proceeds to 412 and the user may define or identify one or more elements within the ingested stream script. In one embodiment, the ingested stream script describes a single element, such as, by non-limiting example, a single song. In another embodiment, the user may define multiple elements which could be performed in any order, such as, by non-limiting example, a musician's library of songs that could be performed by request from the viewers of the live stream. Elements may occur in any order during the stream. In the next step 414, the user may then select which global TAS will be inactive for the selected element. If the user would like a particular global TAS to be inactive for the specific element, the user may de-select/disable the global TAS in this step. Step 414 is optional.

Next, the user makes a decision 416 whether they want to set up a local TAS for the selected element. The user may set up a local TAS by entering the TAS definition sub-process 700. The TAS definition sub-process 700 will be described in further detail in FIG. 7. In another embodiment, the user can select a local TAS from a library of previously defined TAS's. If the user does not select to setup a local TAS, the method proceeds to 422 where the user selects to setup one or more milestone action sets (MAS) for the selected element. After the TAS definition sub-process the method for onboarding may include writing a local TAS to the stream definition 118 in 418. The triggers with the selected associated action(s) create a trigger action set. The local TAS may then be written to the stream definition 118, and the method proceeds to 420. The stream definition 118 can exist in the form of a file, database, or other entity. Once the local TAS has been added to the stream definition, in 420, the user is asked whether they would like to add more local TAS's to the stream definition. If yes, they can start the process of adding a local TAS again, proceeding to step 416 and re-initiating the TAS definition sub-process 700 or if not, proceeding to 422.

Next in the method, the user may select one or more performance milestones from the selected element to be setup and matched with specific actions from the action repository. One or more performance milestones can be matched to one action, or the same performance milestone can be matched to multiple actions. For example, when multiple performance milestones are selected, they can be associated with one action or with the same group of actions. In step 422, the user selects whether to setup a Milestone Action Set (MAS) for the selected element. If yes, the user may set up a MAS by entering the MAS definition sub-process 800. In another embodiment, the user can select a MAS from a library of previously defined MAS. If the user does not select to setup a MAS, the method proceeds to 430 where the user selects whether the stream onboarding is completed. Alternatively, the method could proceed to 428 where the user is asked whether the setup for the element is completed, prior to proceeding to 430. The MAS definition sub-process 800 will be described in further detail in FIG. 8. After the MAS definition sub-process, the method for onboarding may include writing the MAS to the stream definition 118 in step 424. The performance milestone(s) with the selected associated action(s) create a MAS. The MAS may then be written to the stream definition 118, and the method proceeds to 426. The stream definition 118 can exist in the form of a file, database, or other entity. Once the MAS has been added to the stream definition, in 426, the user is asked whether they would like to add more MASs to the stream definition. If yes, they can start the process of adding a MAS again, re-initiating the MAS definition sub-process 800 or if not, proceeding to 428. In step 428, the user is asked whether setup for the current element is complete. If yes, the method proceeds to step 430. If not, the method proceeds to step 412.

In step 430, the system will ask the user if they have finished the stream onboarding process or whether they would like to initiate it again to make any changes. The changes may include modification, additions, and deletions. In another embodiment, this step also checks whether a stream definition has been successfully created and is non-empty, for example—has the user has matched either triggers or performance milestones or both to actions. If the user has not matched trigger and milestones to actions, the user is prompted to retry the stream onboarding again. In another embodiment, the user may utilize the predictive enhancement and is prompted whether they are satisfied with the stream definition from the predictive enhancement set or would the user like to make edits. If the user indicates that the stream onboarding has been completed and the system has determined it is successful, the stream definition 118, TAS definitions 712, and MAS definitions 810 will be the outputs of the stream onboarding process. If the user selects that the stream onboarding is not complete, the method returns to step 402.

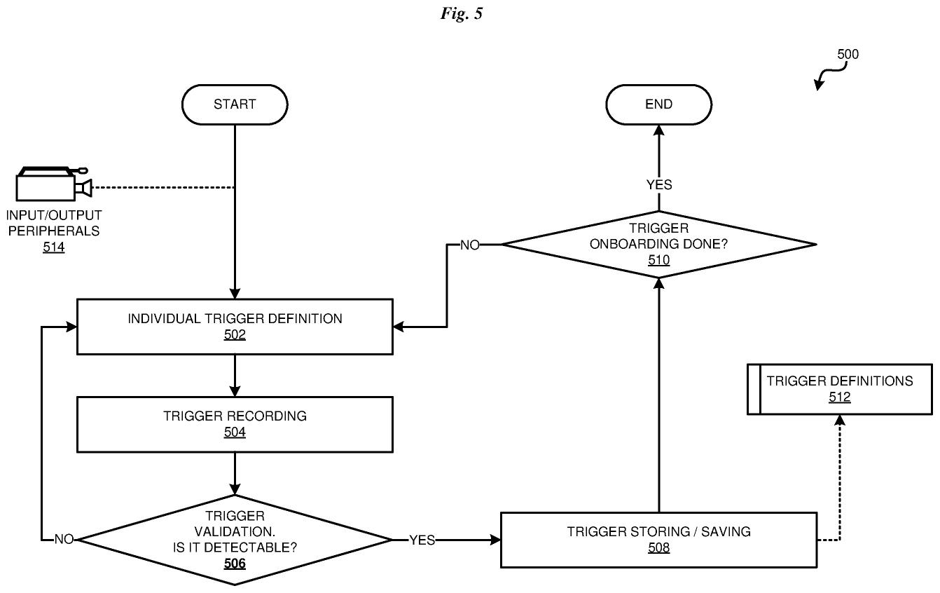

In reference to FIG. 5, the trigger onboarding process is illustrated. Triggers define logic rules that can include language, music or other sounds, actions, and visuals. For example, a trigger can be a specific word or phrase said, or a sound or gesture made as described in the examples in FIG. 3. Triggers may also be a particular part of a melody, lyric, or a chorus. A trigger can be a mouse click or keyboard input. Another example would be a user looking at a specific camera and performing a gesture or specific eye movement. A trigger could also be a combination of these examples such as a particular word is said while the user stands up and raises their hands. During the trigger onboarding process, the user creates a trigger definition by recording, validating, and storing a trigger. Once a trigger has been onboarded, the trigger can be referenced and used by other processes. In this particular embodiment illustrated in FIG. 5, the user manually defines the trigger(s) that will be stored in a trigger repository or library. In another embodiment, pre-recorded and pre-defined triggers would already exist on the repository and can also be used for predictive enhancements.

The method may include defining individual triggers in step 502 where the user may choose or define the type of supported trigger that will be recorded. The user then records a trigger in step 504 using a peripheral input device 514 including but not limited to cameras, microphones, and the like. Input peripheral devices 514 are also illustrated in peripherals 144. The method may then include trigger validation in step 506. The method may include validating peripherals are working and the trigger is detected when tested. If the trigger is successfully validated in step 506, the method proceeds to step 508. If trigger validation is not successful, the method returns to step 502. In step 508, the method may then include saving or storing triggers, as trigger definitions 512, in a trigger library or repository. The trigger may be named for reference within the library for future reference. Proceeding to step 510, the user may then be prompted as to whether they have successfully completed the trigger onboarding process. If the user is not finished, they may start the process again at 502. If the user is done onboarding triggers, the process of trigger onboarding is finished.

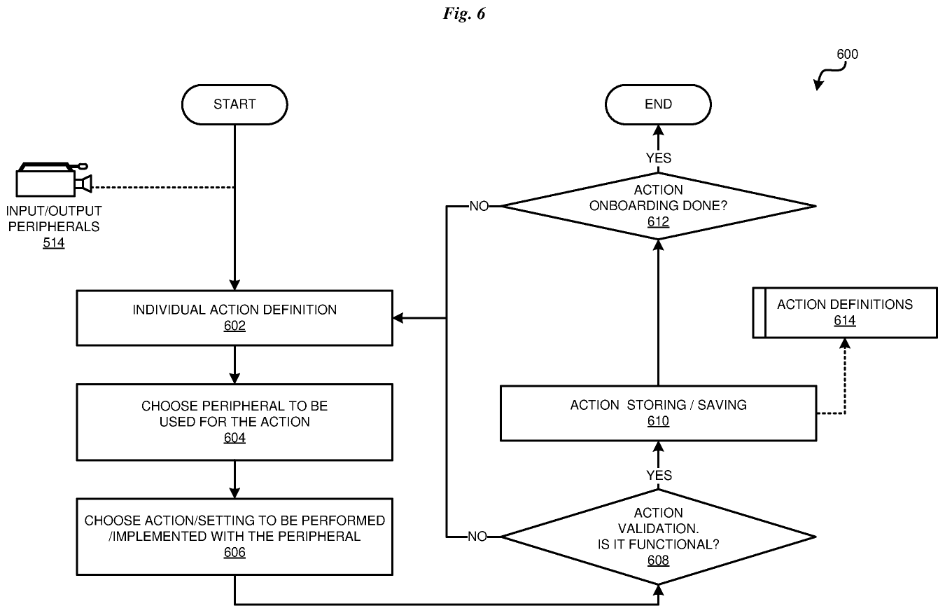

In reference to FIG. 6, an embodiment of an implementation of optimizing live stream productions may include action onboarding. Actions define the enhancements that may occur because of a trigger or performance milestone being identified. The enhancements may be either on peripheral devices local to the streamer, remote to the streamer, or on the stream itself. During the action onboarding process, the user may create an action definition 614 by recording, validating, and storing an action. Once the action has been onboarded, the action may be referenced and used by other live stream optimization processes. In this embodiment, the user may manually define the actions that will be stored in an action repository or library. In another embodiment, pre-recorded and pre-defined actions would already exist in the repository and can also be used or predictive enhancements. The method of onboarding actions may include defining individual actions in step 602. The user may choose or define the type of supported action that will be defined. By non-limiting example, the action may include manipulating output peripheral devices 514 to adjust settings for lights, cameras, instruments, or may including stream enhancements to overlay text, play sounds, and the like. Output peripheral devices 514 are also illustrated in peripherals 144. The user may then choose the peripheral device to be used for the action in step 604. The peripheral device may include a light panel, output screen, speakers, and other peripheral devices that make enhancements to live stream productions. The user may then choose which action or setting is to be performed or implemented with the chosen peripheral device in step 606. The user will then be prompted to validate the peripheral device in step 608 and verify whether the device is functional and appropriately set off by the intended action. If the user or system determines that the peripheral is not functional, or that the action was not successfully completed, then the process returns to step 602. If the peripheral and associated action was successfully validated, then next, in step 610, the user will then be prompted to store or save the action in the library or repository of action definitions 614. The action may be named for reference within the library 614 for future reference. The user will then be prompted whether the action onboarding has been successfully completed in step 612. If onboarding is not complete, the user may continue to add actions to the actions definitions database by returning to step 602. If action onboarding is finished, the user may end the process.

In reference to FIG. 7, a flowchart for the process for an embodiment of defining a Trigger Action Set (TAS) 700 is illustrated. In step 702, the user may select one or more triggers from the trigger repository or library 512. One or triggers may be matched to one or more actions. In various embodiments, one or multiple triggers may be associated with one or multiple actions. In step 704, the method for setting up the TAS definitions also includes validating peripheral devices 514 used as input for the trigger. One or more peripheral devices associated with the selected triggers may be validated to check whether the peripheral device is available and functional. If the peripheral device is not available or functional, the user may select one or more alternative triggers from trigger library 512 by returning to step 702. In another embodiment, the user may be able to troubleshoot the peripheral devices or exclude a specific peripheral device. If the peripherals are validated and functioning, the method proceeds to step 706, where the user may then choose the action, from the action library 614, that will be performed in response to the one or more triggers. In various embodiments, the user may specify different actions to occur with each trigger during the onboarding process. The user may then validate one or more of the peripheral devices associated with the one or more actions in step 708. During the validation process, the peripheral device is checked to make sure it is available and functional. If the peripheral device is not available or functional, the user may choose an alternative action from the action repository 614 by returning to step 706. In another embodiment, the user may be provided the option to troubleshoot the peripheral devices or exclude a specific peripheral device. If the peripherals are validated and functional, the user or system may then determine whether a TAS has been successfully created in step 710. The user may also be prompted whether they wish to define more TASs. If the TAS has not been successfully created, or if the user wishes to define more TASs, they can start the process again in step 702 or decided to end this sub-process. When the process is finished the new TAS definitions are named and stored in the TAS definition repository 712.

In reference to FIG. 8, a flow chart for the process for an embodiment of defining a Milestone Action Set (MAS) 800 is illustrated. In step 802 the user may select one or more performance milestones from the selected element to be setup and matched with specific actions from the action repository 614. One or more performance milestones can be matched to one action or to multiple actions for the same performance milestones. For example, when multiple performance milestones are selected, they may be associated with one or more actions. The actions can be individual, or they can be a group of actions. The user may then choose one or more actions in step 804, from the action repository 614, that will be performed in response to the milestone detected during the live stream event. The one or more peripheral devices may then be validated in step 806. Each of the one or more peripheral devices associated with the selected action may be validated to check whether the peripheral device is available and functional. If the peripheral device is not available or functional, the user may choose an alternative action from the action repository 614 by returning to step 804. In another embodiment, the user may be provided the option to troubleshoot the peripheral devices or exclude a specific peripheral device.

If the peripherals are validated and functional, the user or system may then determine whether a MAS has been successfully created in step 808. The user may also be prompted whether they wish to define more MAS. If the MAS has not been successfully created, or if the user wishes to define more MASs, they can start the process again in step 802 or decide to end this sub-process. When the process is finished the new MAS definitions are named and stored in the MAS definition repository 810.

In reference to FIG. 9, a flow chart of an embodiment of a stream setup 202/900, as referred to in FIG. 2 is illustrated. If the stream onboarding process is completed successfully, a stream definition 118 is created. In step 902, the stream definition may be ingested by the stream setup process to begin the live stream setup. The TAS 114/712 and MAS 116/810 may have been created after stream onboarding which are also provided to the stream setup process 902. In step 902, the format of the stream definition is validated to confirm that the format is appropriate and can be processed by the Optimal Live Stream Management System (OLMS). In step 904, if the stream definition cannot be validated or processed the stream setup will be aborted. In another embodiment, the user may be prompted to provide an alternative stream definition for the stream set up process. If the stream definition is validated, the stream setup may then proceed to 906, where all defined triggers and actions are identified. The process will scan or go through the stream definition to identify all the triggers and actions that have been defined for the live stream. The process may include using the MAS 116/810 and TAS 114/712 definitions to identify which peripherals may be used for MAS and TAS actions.

In step 908, the method for stream setup as illustrated also includes extracting a single trigger or action from the list of identified trigger and actions in order to validate the peripheral devices related to the trigger or action. Each of the one or more peripheral devices associated with the selected trigger or action is validated in step 910 to check whether the peripheral device is available and able to perform the defined functionality. In this step any initial values required for the peripheral devices may also be set, and the peripheral devices is configured in preparation for the live stream. Alternatively, setting of initial values may occur in step 918. Setting of initial values is further described in reference to step 918. In 912, if the peripherals have been validated, the method may proceed to 914. In 912, if the one or more peripheral devices or a specific functionality cannot be validated by the system or the user, the method may proceed to 916, where the user may choose to exclude one or more peripheral devices from the stream setup. This will cause the user to lose the trigger or action implementation for that peripheral during the live stream. If the user decides to not exclude the peripheral that cannot be validated, the stream Setup process may be aborted. In another embodiment, the user will have the option of troubleshooting the peripheral device that has not been successfully validated or is not operational as intended. In another alternative embodiment, the user may be prompted on whether to completely exclude the peripheral device from the stream and to continue the stream setup or to abort and end the stream setup process. In yet another embodiment, the user would be able to troubleshoot the peripheral device or choose an alternative peripheral device and action to use. In 914, the system or user determines if all peripheral devices associated with the extracted trigger and actions have been processed. If all peripheral devices have not yet been validated, the user may restart the peripheral device validation by returning to step 908 and extracting the next trigger or action.

Once the peripheral devices have been validated, in 918, the user or system may go through the validated peripheral devices and set the initial value for each peripheral device. The initial values are set for the respective functionality of the peripheral devices that have been validated. By non-limiting example, if a light peripheral device has been validated and it is validated functionality includes changing color and increasing/decreasing brightness, setting the initial values will include setting the color and brightness. If the color changing functionality was not validated, but brightness functionality was validated, the user will be able to only set an initial value for brightness. If during the above process any trigger or action functionality was not validated, the light may be excluded overall, and the initial value of the light would not be set at this point. Further, in another embodiment, a list of peripherals to be validated may be compiled and the peripheral devices and associated functionality would be validated only once instead of independently based on the trigger or action being processed. Once the initial values have been set, the method may proceed to stream element identification 204/1000.

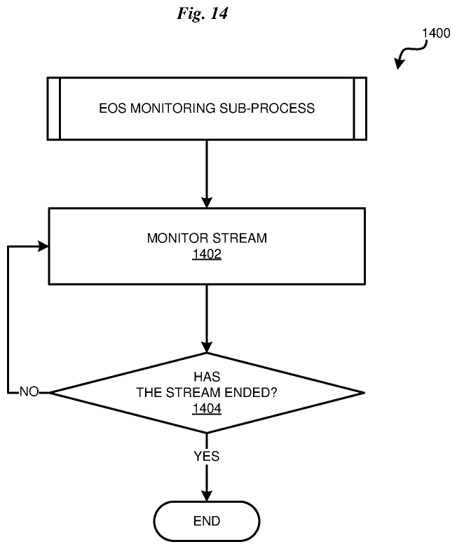

In reference to FIG. 10, a flowchart of an implementation of stream element identification 1000, as referred to in FIG. 2 as 204, is illustrated. The goal of element identification is to identify the element the user is in during the live stream. For example, what song or what part of the stream script the user is currently performing. Once the active element is identified, the system can start analysis of the element and take appropriate action based upon the configuration of TAS and MAS. Stream element identification starts with waiting for the live stream to start 1002. In 1004, the system will check whether the user has started the stream. If the user has not started the stream, the system will continue to wait by returning to 1002. If in 1004, the system determines that the user has started the stream, the method proceeds to 1006 where the end-of-stream monitoring sub-process is started. This subprocess is assumed to be running during the rest of the streaming process and is described in FIG. 14. The implementation of this process aims to continuously monitor whether the stream has ended either manually by the streamer, abruptly by a crash, or automatically by reaching the end of the stream in the stream definition. This subprocess may run in parallel during all processes as described herein.

For triggers and performance milestones to apply, the system must be within an active element. In step 1008, the method determines whether elements have been defined in the stream definition. If no elements have been defined, the method proceeds to 1010, and the system assumes that the entire script is a single element. The script will be identified as the single active element for which global triggers will apply. In another embodiment, user may select to have global triggers apply to all non-element components. In yet another embodiment, users may define a default element that may include all non-element components remaining after the user element definition. If a single active element is defined for the stream, the method proceeds to 1016. If in step 1008, elements have been defined in the stream definition, then the method proceeds to 1012. In 1012, an active element may be identified using Natural Language Processing (NLP) based on the elements defined. In embodiments, the active element may be identified through video analysis of the live steam based on the elements defined. In 1012, the method for stream element identification may include monitoring the stream using NLP or through analysis of the audio/music of the live stream. During the monitoring stage, if NLP or the audio/music analysis discover a match between the live stream and the elements defined during stream onboarding, an element has been identified. If an element has been successfully identified in step 1014, the element identification process is complete at this time and the active element will be stored at step 1016 in an active element library 1018. If no element has been identified in step 1014, the system will continue to monitor the stream using NLP and audio/music analysis by returning to step 1012. Once an active element has been identified, the method may proceed to stream synchronization 206/1100.

In reference to FIG. 11, a flowchart of stream synchronization 1100, as referred to in FIG. 2 as 206, is illustrated. Stream synchronization uses the active element identified to synchronize to the current point in the live stream. When this occurs, the stream synchronization matches the stream definition of the active element to the live stream and keeps track of the upcoming performance milestones based on the location of the current active element of the system. If the stream element identification process is completed successfully, an active element 1018 is created. The active element is ingested by the stream synchronization process in 1102 to begin the live stream synchronization. The system then checks whether one or more multiple performance milestones have been defined for the currently ingested active element 1104.

If the active element does not have any associated performance milestones, the method proceeds to trigger identification 208/1200 as described in FIG. 12. If the active element does have associated performance milestones, then in 1106, the method then includes monitoring the stream using NLP or through analysis of the audio/music of the live stream. In various embodiments, during the monitoring stage 1106, if NLP or audio/music analysis discover a match between the live stream and active element definition, the system can synchronize with the current location of the active element and identify which performance milestone will be coming next in the active element. In this embodiment, an active element and the defined performance milestones follow a sequential order which the stream synchronization utilizes to keep track of the current data point within the active element and the upcoming performance milestone. In another embodiment, stream synchronization could also identify whether a performance milestone within the active element has been skipped and move on to the next performance milestone in the active element. In still another embodiment, the system could determine that the stream has left the active element and revert to monitoring for the active element as described in step 1012. In 1106, the system checks for any upcoming performance milestones. If in 1108 upcoming performance milestones have not been identified, the method returns to 1106 and continues to monitor within the active element. In 1108, if any upcoming performance milestones have been identified, the method proceeds to 1110 and any one or more identified upcoming performance milestones are stored into an active and upcoming performance milestone array 1112. Once upcoming performance milestones have been identified and stored, the method may proceed to trigger identification 208/1200 as described in FIG. 12.

In reference to FIG. 12, a flowchart of trigger identification 1200, as referred to in FIG. 2 as 208, is illustrated. The goal of trigger identification is to identify triggers during the live stream that have been defined for the active element. Once a trigger has been identified for the active element, the respective TAS definition is used to execute the action(s) associated with the trigger. The method of trigger identification includes monitoring 1202 the stream through NLP or through analysis of the audio/music of the live stream. During the monitoring stage, if NLP of audio/music analysis discover a match between the active element 1018 of the live stream and a local or global trigger defined as part of the active element TASs, it may proceed with taking associated action(s). Once a trigger has been identified in step 1204, the method may include executing 1206 the one or more actions associated with the identified trigger based on the global or local TAS definition for the current active element. The method will then proceed to 1202 to monitor the stream for any other triggers. If no trigger is identified, the process may continue to performance milestone identification 210/1300 as described in FIG. 13. The processes illustrated in FIGS. 11, 12, and 13 may run in a loop or in parallel continuously checking for triggers and performance milestones defined for the active element, as well as synchronizing to the stream to confirm the current active element.

In reference to FIG. 13, a flowchart of performance milestone identification 1300, as referred to in FIG. 2 as 210, is illustrated. The goal of performance milestone identification is to identify performance milestones during the live stream that have been defined for the active element. Once a performance milestone has been identified for the active element, the respective MAS definition is used to execute the action(s) associated with the performance milestone. The active and upcoming performance milestone array 1112 is ingested by this process. If the array 1112 is empty, or otherwise indicates that there are no upcoming or active performance milestones, then the method would skip this process and proceed to 212 as indicated in FIG. 2. In 1302, the first upcoming performance milestone is extracted from array 1112 to monitor the stream for it. In 1304, the method includes monitoring the stream using NLP or through analysis of the audio or music of the live stream. In embodiments, monitoring for performance milestones may include monitoring of the video content of the live steam. In 1306, if the NLP or audio/music analysis discover a match between the active element of the live stream and the extracted performance milestone, defined as part of the active element MASs, the method proceeds with taking the associated action(s) in step 1308. If the upcoming performance milestone has not yet been detected, the system continues to monitor in step 1304. Alternatively, the system may proceed to 212 as indicated in FIG. 2 to continue executing the loop of checking for active elements, triggers, and performance milestones. In this embodiment, a single upcoming performance milestone is tracked by the array 1112. In another embodiment, monitoring steps 1304 and 1306 would keep track of the whole array of upcoming performance milestones and monitor the stream against that, allowing detection of “skipped” performance milestones and moving to the next performance milestone in the array if one or multiple performance milestones were skipped. In embodiments, the system may continue to monitor for the upcoming performance milestone in parallel to other processes for element and trigger identification. Once the upcoming performance milestone has been detected, in 1308 the system executes the action(s) defined in the MAS definition. Once the action(s) have been executed, the method proceeds to 212 as indicated in FIG. 2 to determine if the end of the active element has been reached.

In reference to FIG. 14, a flowchart of the end-of-stream monitoring sub-process 1400 is illustrated. End of Stream (EoS) is a subprocess assumed to be running continuously and in parallel to all processes once the stream has started. Its implementation aims to continuously monitor whether the stream has ended either manually by the streamer, abruptly by a crash, or automatically by reaching the end of the stream in the stream definition. In 1402 the system monitors to determine if the stream has ended. In 1404, if the system determines the stream has not ended, it continues monitoring in 1402. If the stream has ended, this determination is used for decision 214 in FIG. 2. In embodiments, the processes illustrated in FIGS. 10, 11, 12, 13, and 14 may run in parallel during a live steam.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

1-20. (canceled)

21. A computer-implemented method comprising:
establishing a stream definition, the stream definition comprising a database configured to store set of markers and a set of actions corresponding to the set of markers;
constructing a performance milestone and a first action corresponding to the performance milestone, the performance milestone specifying a scripted nonverbal event in a script for a live stream event, the first action specifying a first real time change to the live stream event;
annotating, prior to commencement of the live stream event, the script, the annotating comprising adding a marker representing the performance milestone and the first action to be executed upon detection of the marker to the script;
storing the marker representing the performance milestone and the first action to be executed upon detection of the marker on the stream definition;
detecting, by monitoring an input from a peripheral device local to a performer in the live stream event during the live stream event, an occurrence of the performance milestone, wherein the monitoring comprises comparing the live stream event to the stream definition; and
executing, responsive to detecting the occurrence of the performance milestone, the first action, wherein executing the first action causes the first real time change to the live stream event.

22. The computer-implemented method of claim 21, wherein the performance milestone comprises a combination of multiple distinct performance milestones, the combination of multiple distinct performance milestones defined using a Boolean logic construct.

23. The computer-implemented method of claim 21, further comprising:
constructing a trigger and a second action corresponding to the performance milestone, the trigger specifying a nonverbal event, the second action specifying a second real time change to the live stream event;
detecting, by monitoring the input from the peripheral device during the live stream event, an occurrence of the trigger; and
executing, responsive to detecting the occurrence of the trigger, the second action, wherein executing the second action causes the second real time change to the live stream event.

24. The computer-implemented method of claim 23, wherein the trigger comprises a combination of multiple distinct triggers, the combination of multiple distinct triggers defined using a Boolean logic construct.

25. The computer-implemented method of claim 21, wherein constructing the performance milestone further comprises specifying an element of the live stream event to which the performance milestone applies, the element comprising a pre-defined sub-component of the script for the live stream event.

26. The computer-implemented method of claim 25, further comprising:
detecting, by monitoring the input from the peripheral device during the live stream event, the element of the live stream event;
detecting, by monitoring the input from the peripheral device during the element of live stream event, the occurrence of the performance milestone; and
executing, responsive to detecting the occurrence of the performance milestone during the element, the first action.

27. The computer-implemented method of claim 21, further comprising:
generating, by analyzing the script and the performance milestone, a second performance milestone, the second performance milestone specifying a second scripted nonverbal event in a second script for a second live stream event.

28. A computer program product comprising one or more computer readable storage media, and program instructions collectively stored on the one or more computer readable storage media, the program instructions executable by a processor to cause the processor to perform operations comprising:
establishing a stream definition, the stream definition comprising a database configured to store set of markers and a set of actions corresponding to the set of markers;
constructing a performance milestone and a first action corresponding to the performance milestone, the performance milestone specifying a scripted nonverbal event in a script for a live stream event, the first action specifying a first real time change to the live stream event;
annotating, prior to commencement of the live stream event, the script, the annotating comprising adding a marker representing the performance milestone and the first action to be executed upon detection of the marker to the script;
storing the marker representing the performance milestone and the first action to be executed upon detection of the marker on the stream definition;
detecting, by monitoring an input from a peripheral device local to a performer in the live stream event during the live stream event, an occurrence of the performance milestone, wherein the monitoring comprises comparing the live stream event to the stream definition; and
executing, responsive to detecting the occurrence of the performance milestone, the first action, wherein executing the first action causes the first real time change to the live stream event.

29. The computer program product of claim 28, wherein the stored program instructions are stored in a computer readable storage device in a data processing system, and wherein the stored program instructions are transferred over a network from a remote data processing system.

30. The computer program product of claim 28, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

31. The computer program product of claim 28, wherein the performance milestone comprises a combination of multiple distinct performance milestones, the combination of multiple distinct performance milestones defined using a Boolean logic construct.

32. The computer program product of claim 28, further comprising:
constructing a trigger and a second action corresponding to the performance milestone, the trigger specifying a nonverbal event, the second action specifying a second real time change to the live stream event;
detecting, by monitoring the input from the peripheral device during the live stream event, an occurrence of the trigger; and
executing, responsive to detecting the occurrence of the trigger, the second action, wherein executing the second action causes the second real time change to the live stream event.

33. The computer program product of claim 32, wherein the trigger comprises a combination of multiple distinct triggers, the combination of multiple distinct triggers defined using a Boolean logic construct.

34. The computer program product of claim 28, wherein constructing the performance milestone further comprises specifying an element of the live stream event to which the performance milestone applies, the element comprising a pre-defined sub-component of the script for the live stream event.

35. The computer program product of claim 34, further comprising:
detecting, by monitoring the input from the peripheral device during the live stream event, the element of the live stream event;
detecting, by monitoring the input from the peripheral device during the element of live stream event, the occurrence of the performance milestone; and
executing, responsive to detecting the occurrence of the performance milestone during the element, the first action.

36. The computer program product of claim 28, further comprising:
generating, by analyzing the script and the performance milestone, a second performance milestone, the second performance milestone specifying a second scripted nonverbal event in a second script for a second live stream event.

37. A computer system comprising a processor and one or more computer readable storage media, and program instructions collectively stored on the one or more computer readable storage media, the program instructions executable by the processor to cause the processor to perform operations comprising:
establishing a stream definition, the stream definition comprising a database configured to store set of markers and a set of actions corresponding to the set of markers;
constructing a performance milestone and a first action corresponding to the performance milestone, the performance milestone specifying a scripted nonverbal event in a script for a live stream event, the first action specifying a first real time change to the live stream event;
annotating, prior to commencement of the live stream event, the script, the annotating comprising adding a marker representing the performance milestone and the first action to be executed upon detection of the marker to the script;
storing the marker representing the performance milestone and the first action to be executed upon detection of the marker on the stream definition;
detecting, by monitoring an input from a peripheral device local to a performer in the live stream event during the live stream event, an occurrence of the performance milestone, wherein the monitoring comprises comparing the live stream event to the stream definition; and
executing, responsive to detecting the occurrence of the performance milestone, the first action, wherein executing the first action causes the first real time change to the live stream event.

38. The computer system of claim 37, wherein the performance milestone comprises a combination of multiple distinct performance milestones, the combination of multiple distinct performance milestones defined using a Boolean logic construct.

39. The computer system of claim 37, further comprising:
constructing a trigger and a second action corresponding to the performance milestone, the trigger specifying a nonverbal event, the second action specifying a second real time change to the live stream event;
detecting, by monitoring the input from the peripheral device during the live stream event, an occurrence of the trigger; and
executing, responsive to detecting the occurrence of the trigger, the second action, wherein executing the second action causes the second real time change to the live stream event.

40. The computer system of claim 39, wherein the trigger comprises a combination of multiple distinct triggers, the combination of multiple distinct triggers defined using a Boolean logic construct.
